(19) United States
(12) Patent Application Publication
(10) Pub. No.: US 2010/0231679 A1
(43) Pub. Date: Sep. 16, 2010

(54) THERMAL PRINTER

(75) Inventor: Ken Masuda, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/714,779

(22) Filed: Mar. 1, 2010

(30) Foreign Application Priority Data
Mar. 10, 2009 (JP) 2009-056842

(51) Int. Cl. B41J 2/36

(52) U.S. Cl. 347/184

(57) ABSTRACT

In a thermal printer, a first thermal head to print data on one surface of a print medium both surfaces of which are colored in different colors or a second thermal head to print data on the other surface of the print medium different from the print surface of the first thermal head is controlled, and a test image is printed on the print medium set in the thermal printer. Then, in the thermal printer, a print density of the printed test image is detected, and based on the detected print density of the test image and information stored in a density information storage section, it is determined whether the front and the back of the print medium set in the thermal printer is normal.

### CROSS-REFERENCE TO RELATED APPLICATION

This application is based upon and claims the benefit of priority from the prior Japanese Patent Application No. 2009-056842, filed Mar. 10, 2009, the entire contents of which are incorporated herein by reference.

### TECHNICAL FIELD

The present invention relates to a thermal printer to print on a print medium, such as thermal paper, in at least two colors.

### BACKGROUND

In a hitherto known thermal printer, a print medium such as thermal paper is conveyed to a contact position where a thermal head including heat generating elements disposed in a line contacts with a platen roller disposed to be opposite to the head, and an applied voltage to the thermal head is controlled to cause the print medium to be colored and to form a print pattern. In some thermal printers, not only printing is performed on one side of a print medium in a single color, but also printing is performed on both sides of a print medium, or printing is performed on one side of a print medium in two colors.

When printing is performed by a thermal printer capable of performing duplex printing, it is necessary to use a print medium in which a thermosensitive layer is formed on both sides. Thus, when a print medium in which a thermosensitive layer is formed only one side is erroneously used, a print result desired by the user can not be obtained. In view of such circumstances, the invention disclosed in, for example, JP-A-2008-6802 is made. The thermal printer of this invention is constructed such that a mark sensor is used to determine whether a print medium is for duplex printing, and when it is for duplex printing, duplex printing is performed.

When printing in two colors is performed by the thermal printer capable of performing printing in two colors, it is necessary to use a print medium in which thermosensitive layers for two color printing are formed. Plural kinds of print media for two color printing in which applied voltages required for coloring are different are circulated on the market. Thus, when a print medium different from a proper one is used, a print result desired by the user can not be obtained. In view of such circumstances, the invention disclosed in, for example, JP-A-2002-292915 is made. The thermal printer of this invention is constructed such that the kind of a print medium is specified, and a control method of a thermal head is changed to a system suitable for the print medium according to the result.

In the print media for duplex printing, there is a case where developed colors are different between one surface and the other surface. When such a print medium is used, even if the user desires that the front surface is printed in a first color and the back surface is printed in a second color, when the print medium is set while the front and the back thereof is inversely arranged, a print result desired by the user can not be obtained.

Besides, although the user desires to print on one side of a print medium in two colors, when a print medium which is colored only in one color is set, a print result desired by the user can not be obtained.

These problems can not be dealt with by the inventions disclosed in JP-A-2008-6802 and JP-A-2002-292915.

### SUMMARY

The present invention is made under such circumstances, and provides a thermal printer in which it is determined whether a print result desired by a user is obtained by a set print medium, and an output of a print result not intended by the user is prevented.

According to an aspect of the invention, a thermal printer includes a first thermal head to print data on one surface of a print medium in which both surfaces are colored in different colors, a second thermal head to print data on the other surface of the print medium different from the print surface of the first thermal head, a density information storage section to store information relating to a density of a first color printed on the one surface of the print medium by the first thermal head and information relating to a density of a second color printed on the other surface of the print medium by the second thermal head, a test image print section to print a test image on the print medium set in the thermal printer by controlling the first thermal head or the second thermal head, a density detection section to detect a print density of the test image printed by the test image print section, and a determination section to determine whether a front and a back of the print medium set in the thermal printer is normal based on the print density of the test image detected by the density detection section and the information stored in the density information storage section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a principal structure of a thermal printer in a first embodiment of the invention.

FIG. 2 is a view showing a print mechanism of the thermal printer in the embodiment.

FIG. 3 is a schematic view showing a structure of a print medium in the embodiment.

FIG. 4 is a schematic view showing a data structure of a threshold storage area in the embodiment.

FIG. 5 is a flowchart of processing executed by a CPU in the embodiment.

FIG. 6 is a schematic view in which a print mechanism in the embodiment is seen from an arrow A direction.

FIG. 7 is a schematic view showing a temporal change of a detected value of a density sensor in the embodiment.

FIG. 8 is a schematic view showing a structure of a print medium in a second embodiment of the invention.

FIG. 9 is a flowchart of processing executed by a CPU in the embodiment.

FIG. 10 is a schematic view in which a print mechanism in the embodiment is seen from the arrow A direction.

FIG. 11 is a schematic view showing a temporal change of a detected value of a density sensor in the embodiment.

### DETAILED DESCRIPTION

Hereinafter, a first embodiment of the invention will be described with reference to the drawings.

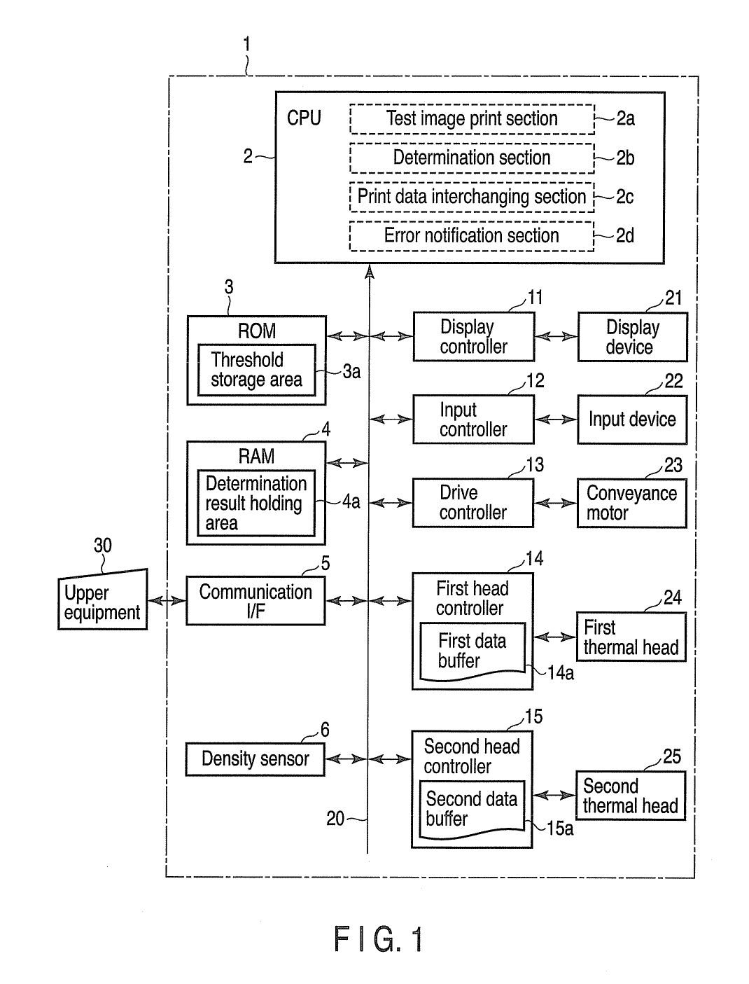

FIG. 1 is a block diagram showing a principal structure of a thermal printer 1 of the embodiment of the invention. The thermal printer 1 includes a CPU (Central Processing Unit) 2 as the center of control.

The CPU 2 is connected with a ROM (Read Only Memory) 3, a RAM (Random Access Memory) 4, a communication interface (I/F) 5, a density sensor 6, a display controller 11, an input controller 12, a drive controller 13, a first head controller 14 including a first data buffer 14a, a second head controller 15 including a second data buffer 15a, and the like through a bus line 20 such as an address bus or a data bus.

An upper equipment 30 such as a personal computer is connected to the communication interface 5, and a display device 21 is connected to the display controller 11. An input device 22 is connected to the input controller 12, and a conveyance motor 23 to drive a conveyance roller to convey a print medium is connected to the drive controller 13. A first thermal head 24 is connected to the first head controller 14, and a second thermal head 25 is connected to the second head controller 15.

The ROM 3 includes a threshold storage area 3a (density information storage section). Specified thresholds used in an after-mentioned processing are previously stored in the threshold storage area 3a.

The RAM 4 forms a work storage area such as a determination result holding area 4a (determination result holding section) according to a processing scene of the thermal printer 1. The determination result holding area 4a stores and holds a determination result in the after-mentioned processing executed by the CPU 2.

When receiving a command from the upper equipment 30, the communication interface 5 notifies the CPU 2 of the command, and when receiving print data, the communication interface outputs the received print data to the first data buffer 14a or the second data buffer 15a.

The density sensor 6 (density detection section) detects the print density of a test pattern (test image) printed by the second thermal head and notifies the CPU 2 of the density.

The display device 21 includes a liquid crystal display or an LED. The display controller 11 controls the display device 21 to display various information.

The input device 22 includes an operation key or a touch panel provided on the display surface of the display device 21. The input controller 12 detects a signal outputted according to the operation of the user from the input device 22, and notifies the CPU 2 of the signal.

Each of the first thermal head 24 and the second thermal head 25 includes heat generating elements disposed in a line shape. The first head controller 14 controls an applied voltage to the heat generating elements of the first thermal head 24 based on the print data stored in the first data buffer 14a as a first print data storage unit. The second head controller 15 controls an applied voltage to the heat generating elements of the second thermal head 25 based on the print data stored in the second data buffer 15a as a second print data storage unit.

The CPU 2 includes control sections to realize characteristic control in the embodiment, that is, a test image print section 2a, a determination section 2b, a print data interchanging section 2c, and an error notification section 2d.

The test image print section 2a controls the first thermal head 24 or the second thermal head 25 to print the test image on the print medium set in the thermal printer 1. Especially, in this embodiment, the second thermal head 25 is used to print the test image.

The determination section 2b determines, based on the print density of the test image detected by the density sensor 6 and the thresholds α and β stored in the threshold storage area 3a, whether the front and the back of the print medium set in the thermal printer 1 is normal.

When the determination section 2b determines that the front and the back of the print medium set in the thermal printer 1 is not normal, the print data interchanging section 2c interchanges the print data stored in the first data buffer 14a and the print data stored in the second data buffer 15a.

The error notification section 2d notifies the user of various errors occurring in the thermal printer 1.

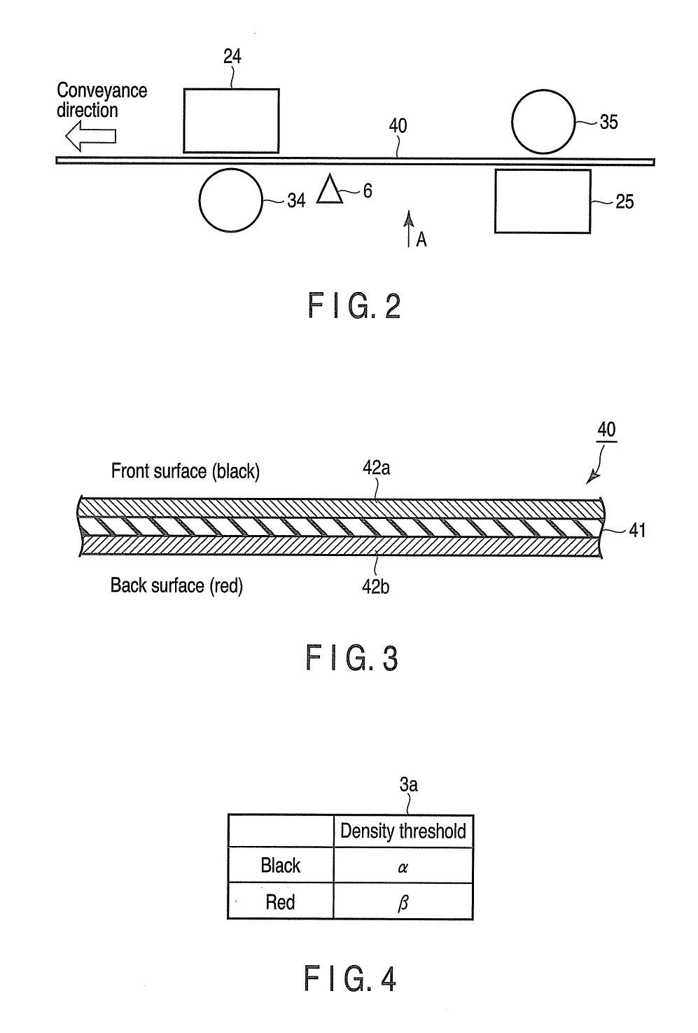

The print mechanism of the thermal printer 1 will be described by use of FIG. 2. The second thermal head 25 is disposed upstream of the arrangement position of the first thermal head 24 in the conveyance direction of a print medium 40. A first platen roller 34 is disposed to be opposite to the first thermal head 24 through the print medium 40, and a second platen roller 35 is disposed to be opposite to the second thermal head 25 through the print medium 40. The density sensor 6 is provided between the opposite position between the first thermal head 24 and the first platen roller 34 and the opposite position between the second thermal head 25 and the second platen roller 35.

As shown in FIG. 3, the print medium 40 used for printing in the thermal printer 1 includes a base sheet 41, a thermosensitive layer 42a formed on one surface of the base sheet 41, and a thermosensitive layer 42b formed on the other surface of the base sheet 41. The thermosensitive layer 42a is colored black (first color) when receiving heat of a specified temperature or higher. On the other hand, the thermosensitive layer 42b is colored red (second color) when receiving heat of a specified temperature or higher. In this embodiment, the thermosensitive layer 42a side of the print medium 40 is the front surface, and the thermosensitive layer 42b side is the back surface. Generally, the first thermal head 24 prints on the front surface of the print medium 40, and the second thermal head 25 prints on the back surface of the print medium 40.

FIG. 4 is a schematic view showing the data structure of the threshold storage area 3a stored in the ROM 3. The threshold α as the first threshold and the threshold β as the second threshold are stored in the threshold storage area 3a. The threshold α is the threshold to separate print densities for black and red. The threshold β is the threshold to separate print densities for the ground color of the print medium 40 and red. In general, the print density for black is higher than that for red (α>β). Accordingly, it can be determined that when the detected value L detected by the density sensor 6 is not less than the threshold β and less than the threshold α (β≦L<α), the printed pattern is red, and when the detected value is not less than α (α≦L), the printed pattern is black.

Next, the operation of the thermal printer 1 having the structure as described above will be described.

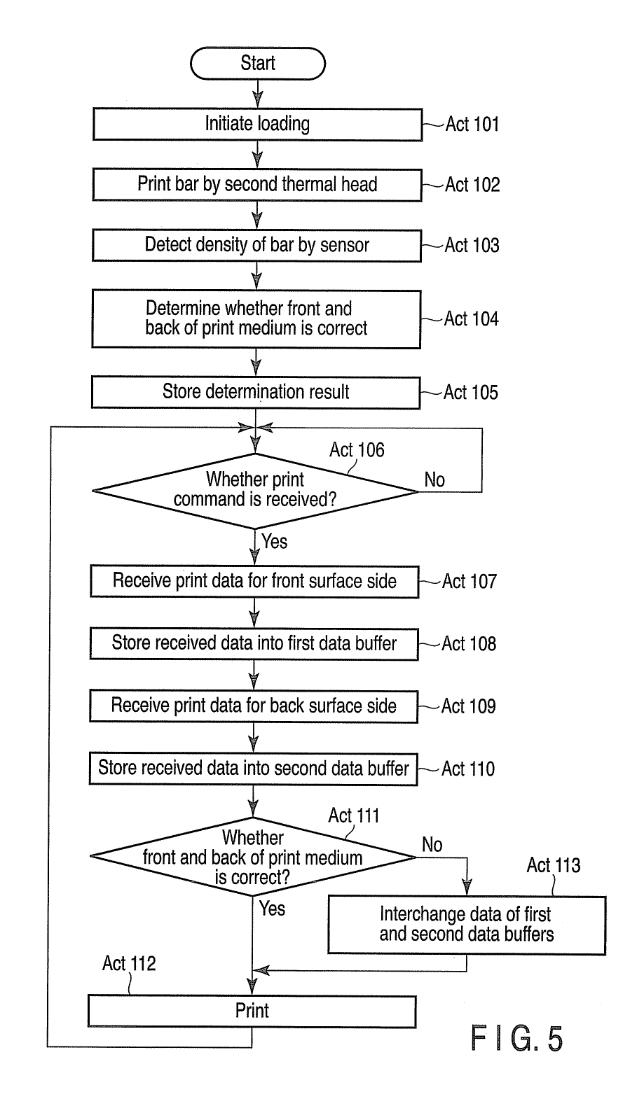

FIG. 5 is a flowchart of processing executed by the CPU 2 when the system of the thermal printer 1 is started or the print medium 40 is set in the thermal printer 1. This processing is realized by the test image print section 2a, the determination section 2b, the print data interchanging section 2c and the error notification section 2d.

First, the CPU 2 initiates loading of the print medium 40 (Act 101). Specifically, the conveyance motor 23 drives the conveyance roller to convey the print medium 40 from a sheet tray (not shown) in which the print medium 40 is contained to the opposite position (print position) between the second thermal head 25 and the second platen roller 35.

After the print medium 40 is conveyed to the print position of the second terminal head 25, the CPU 2 instructs the second head controller 15 to print a test pattern (Act 102). When receiving this instruction, the second head controller 15 controls power distribution to the second thermal head 25 to print the test pattern on the print medium 40.

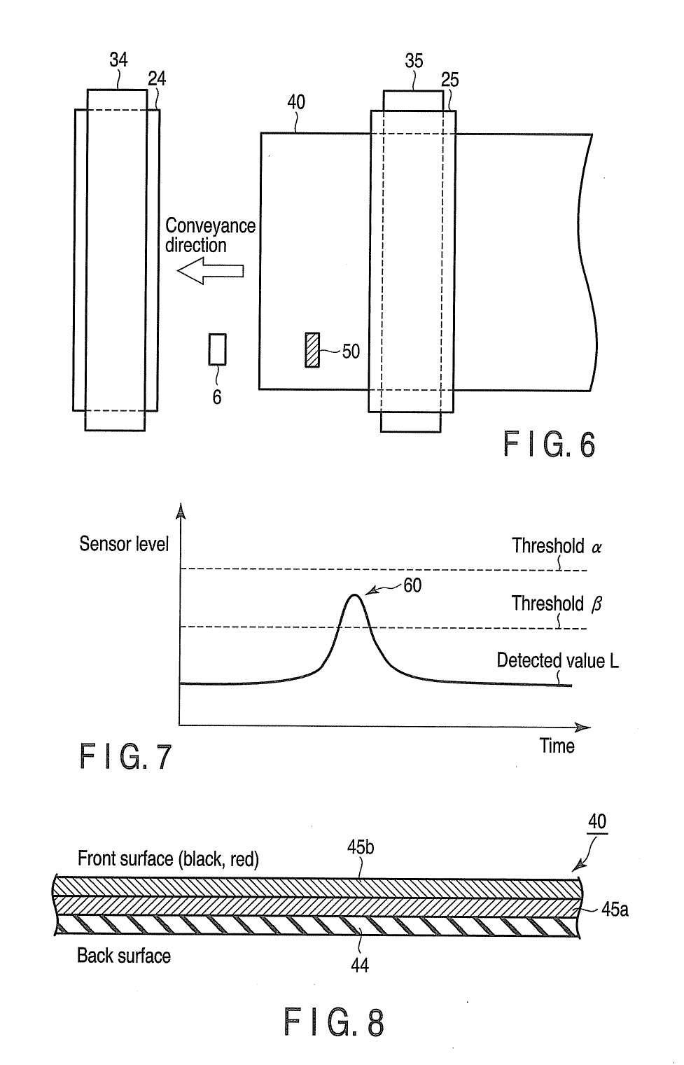

FIG. 6 is a schematic view in which the print medium 40 printed with the test pattern by the print mechanism shown in FIG. 2 is seen from an arrow A direction. By the processing of Act 102, the second thermal head 25 prints a bar 50 as the test pattern on, for example, a conveyance line passing through above the density sensor 6 as shown in the drawing. The bar 50 is printed on the conveyance line passing through above the density sensor 6 as stated above, so that the density sensor 6 can detect the print density.

After the bar 50 as the test pattern is printed, the CPU 2 causes the conveyance motor 23 to continue to convey the print medium 40. Then, the CPU 2 causes the density sensor 6 to detect the print density of the print medium 40 before and after the bar 50 passes through the installation position of the density sensor 6 (Act 103).

Here, the print density detected by the density sensor 6 will be described. FIG. 7 is a schematic view showing a temporal change of a detected value L of the density sensor 6 when the back surface of the print medium 40 is set to face the second thermal head 25. The detected value L is lower than both the thresholds α and β after the density sensor 6 starts the detection of the print density and until the bar 50 reaches the detection position of the density sensor 6. When the bar 50 reaches the detection position of the density sensor 6, the detected value L increases, and after the bar 50 passes through the detection position of the density sensor 6, the detected value decreases. In the detection result of the print density obtained by the density sensor 6, a point where the curve of the detected value L becomes the peak is defined as an apex 60.

After the density sensor 6 detects the print density, the CPU 2 determines whether the front and the back of the print medium 40 is correctly set (Act 104).

Specifically, the CPU 2 regards the apex 60 in the change of the detected value L shown in FIG. 7 as the print density of the bar 50, and compares the print density with the thresholds α and β. Next, the determination section 2b determines whether the bar 50 is red or black. At this time, when the apex 60 is not less than the threshold β and less than the threshold α (β≦L<α), the CPU 2 determines that the bar 50 is red, and when the apex is not less than the threshold α (α≦L), the CPU determines that the bar 50 is black. In this embodiment, when the thermosensitive layer 42b as the back surface of the print medium 40 faces the second thermal head 25, the front and the back of the print medium 40 is correct. Accordingly, when it is determined that the bar 50 is red, the CPU 2 determines that the front and the back of the print medium 40 is correct.

On the other hand, when it is determined that the bar 50 is black, there is a possibility that the front and the back of the print medium 40 is inversely arranged. Besides, when it can not be determined that the bar 50 is red or black, there is a possibility that although the print medium 40 is for duplex printing, it is for one-color printing, or the print medium 40 is for one-side printing. In such a case, the CPU 2 determines that the front and the back of the print medium 40 is not correctly set.

Next, the CPU 2 stores the determination result of the operation of Act 104 into the determination result holding area 4a formed in the RAM 4 (Act 105). Thereafter, the CPU 2 waits for the reception of a print command from the upper equipment 30 (Act 106).

When receiving the print command from the upper equipment 30 through the communication interface 5 (Yes at Act 106), the CPU 2 receives print data for the front surface side of the print medium 40 sent from the upper equipment 30 (Act 107), and stores the received print data into the first data buffer 14a (Act 108). Next, the CPU 2 receives print data for the back surface side of the print medium 40 (Act 109), and stores the received print data into the second data buffer 15a (Act 110). Then, the CPU 2 refers to the determination result stored in the determination result holding area 4a by the operation of Act 105, and determines whether the front and the back of the print medium 40 is correctly set (Act 111).

When the determination result that the front and the back of the print medium 40 is correctly set is stored in the determination result holding area 4a (Yes at Act 111), the CPU 2 instructs the drive controller 13, the first head controller 14 and the second head controller 15 to print. At this time, the drive controller 13 drives the conveyance motor 23 to convey the print medium 40, and in synchronization with that, the first head controller 14 controls the applied energy to the first thermal head 24 based on the print data stored in the first data buffer 14a, and the second head controller 15 controls the applied energy to the second thermal head 25 based on the print data stored in the second data buffer 15a. The print medium 40 printed with the print data on the front surface and the back surface is discharged from a discharge port (not shown) of the thermal printer 1.

On the other hand, when the determination result that the front and the back of the print medium 40 is not correctly set is stored in the RAM 4 (No at Act 111), the CPU 2 interchanges the print data stored in the first data buffer 14a and the print data stored in the second data buffer 15a (Act 113). That is, the CPU 2 stores the print data, which is stored in the second data buffer 15a and is to be printed on the back surface of the print medium 40, into the first data buffer 14a, and stores the print data, which is stored in the first data buffer 14a and is to be printed on the front surface of the print medium 40, into the second data buffer 15a.

Thereafter, the CPU 2 instructs the drive controller 13, the first head controller 14 and the second head controller 15 to print (Act 112). When receiving this instruction, the drive controller 13 drives the conveyance motor 23 to convey the print medium 40, and in synchronization with that, the first head controller 14 controls the applied energy to the first thermal head 24 based on the print data stored in the first data buffer 14a, and the second head controller 15 controls the applied energy to the second thermal head 25 based on the print data stored in the second data buffer 15a. The print medium 40 printed with the print data on the front surface and the back surface is discharged from the discharge port (not shown) of the thermal printer 1. At this time, the CPU 2 causes the display device 21 to display alarm information and notifies the user that the front and the back of the print medium 40 is inversely arranged, and the print data stored in the first data buffer 14a and the print data stored in the second data buffer 15a are interchanged and are printed.

After the discharge of the print medium 40 is completed, the CPU 2 waits for a print instruction from the upper equipment 30 (Act 106).

As described above, in the thermal printer 1 of the embodiment, the test pattern is printed on the print medium 40, and based on the print density of the test pattern and the thresholds α and β stored in the threshold storage area 3a, it is determined whether the front and the back of the print medium 40 is correctly set. By using this determination result, it becomes possible to perform processing to notify the user that the print medium 40 is not in the state suitable for desired duplex printing or to stop the printing. Accordingly, the output of the print result not intended by the user can be prevented.

Besides, when the determination result that the front and the back of the print medium 40 is not correctly set is obtained, the thermal printer 1 interchanges the print data stored in the first data buffer 14a and the data stored in the second data buffer 15a and prints. Thus, even when the front and the back of the print medium 40 is not correctly set, the desired print result can be outputted without troubling the user.

Besides, the printing of the test pattern and the determination as to whether the front and the back of the print medium 40 is correctly set are performed when the system is started, or when the print medium 40 is first loaded after the print medium 40 is set in the thermal printer 1. When the system is started or the print medium 40 is set, the loading of the print medium 40 is generally performed, and the print medium 40 of a specified length is discharged from the discharge port. In view of this, when the printing of the test pattern is performed at the time of loading, the print medium 40 can be saved.

Besides, the determination result as to whether the front and the back of the print medium 40 is correctly set is stored in the determination result holding area 4a formed in the RAM 4. When the determination result stored in the determination result holding area 4a is used, even after one print job is completed, it is not necessary to perform the operation of Act 102 to Act 104 each time the print command is received from the upper equipment 30. Accordingly, the time required for printing using the thermal printer 1 can be shortened.

Next, a second embodiment of the invention will be described.

This embodiment is different from the first embodiment in that when printing is performed using a print medium for two-color printing in which one side is colored in two colors, it is detected whether a print medium set in a thermal printer 1 is for two-color printing. The same portion as the first embodiment is denoted by the same reference numeral and its description is omitted.

In this embodiment, as a print medium of the thermal printer 1, a print medium 43 is used in which printing can be performed on one side in two colors. FIG. 8 is a schematic view showing a structure of the print medium 43. The print medium 43 includes a base sheet 44, a thermosensitive layer 45a formed on one surface of the base sheet 44, and a thermosensitive layer 45b formed on the thermosensitive layer 45a. The thermosensitive layer 45a is colored black when heat of a specified temperature or higher is applied. On the other hand, the thermosensitive layer 45b is colored red when heat of a specified temperature or higher is applied. Incidentally, the temperature at which the thermosensitive layer 45a is colored black is higher than the temperature at which the thermosensitive layer 45b is colored red. Accordingly, when the level of applied energy to the thermal head at printing is selectively changed, printing using two colors of black and red can be performed on the print medium 43.

In this embodiment, the applied energy when the print medium 43 is colored black is first applied energy, and the applied energy when the print medium is colored red is second applied energy. Besides, the second thermal head 25 is used for the printing.

Next, the operation of the thermal printer 1 having the structure as described above will be described.

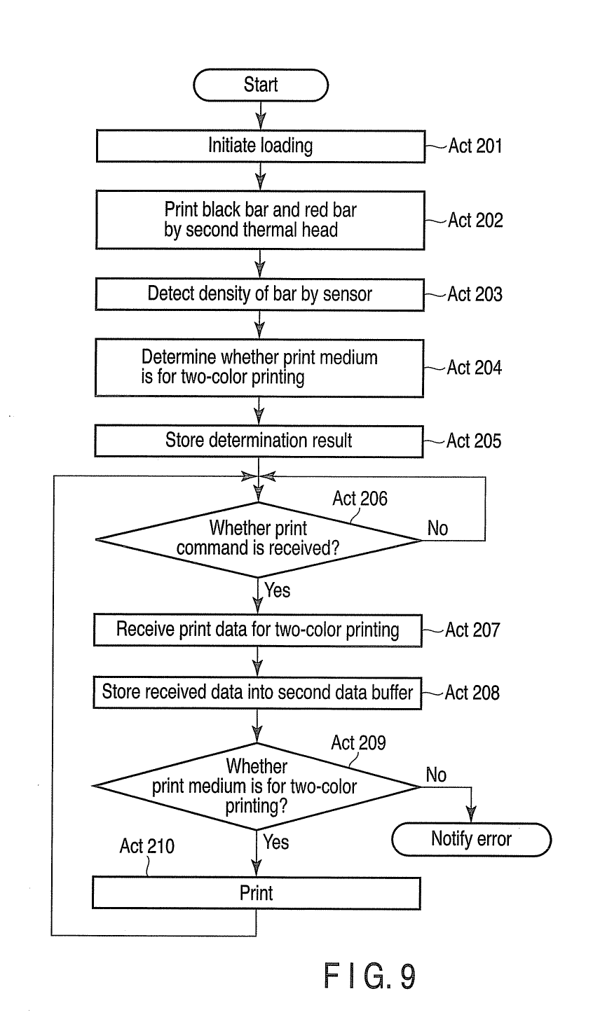

FIG. 9 is a flowchart of processing executed by the CPU 2 when operation power is applied to the thermal printer 1 and the system is started. This processing is realized by the test image print section 2a, the determination section 2b and the error notification section 2d as described before.

First, the CPU 2 initiates loading of the print medium 43 (Act 201). Specifically, the CPU 2 causes the conveyance motor 23 to drive a conveyance roller, and causes the print medium 43 to be conveyed from a sheet tray (not shown) in which the print medium 43 is contained to the opposite position (print position) between the second thermal head 25 and the second platen roller 35.

After the print medium 43 is conveyed to the print position of the second thermal head 25, the CPU 2 instructs the second head controller 15 to print a test pattern (Act 202). When receiving this instruction, the second head controller 15 controls power distribution to the second thermal head 25 and prints the test pattern on the print medium 43.

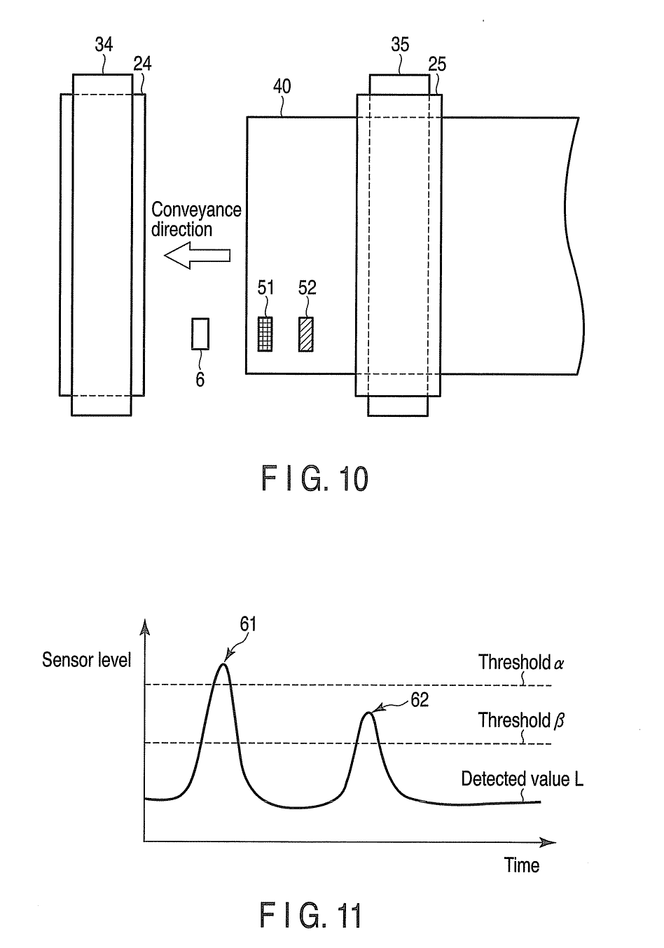

FIG. 10 is a schematic view in which the print medium 43 printed with the test pattern by the print mechanism shown in FIG. 2 is seen from the arrow A direction. By the operation of Act 202, the second thermal head 25 prints two bars 51 and 52 as test patterns on, for example, a conveyance line passing through above the density sensor 6 as shown in the drawing. The bars 51 and 52 are printed on the conveyance line passing through above the density sensor 6, so that the density sensor 6 can detect the print density.

After the bars 51 and 52 as the test patterns are printed, the CPU 2 causes the conveyance motor 23 to continue to convey the print medium 43. Then, the CPU 2 causes the density sensor 6 to detect the print density of the print medium 43 before and after the bars 51 and 52 pass through the installation position of the density sensor 6 (Act 203).

The print density detected by the density sensor 6 will be described. FIG. 11 is a schematic view showing a temporal change of a detected value L of the density sensor 6 when the print medium 43 is the print medium for two-color printing and is set so that the front surface faces the second thermal head 25. The detected value L is lower than both thresholds α and β until the bar 51 reaches the detection position of the density sensor 6 after the density sensor 6 starts the detection of the print density. When the bar 51 reaches the detection position of the density sensor 6, the detected value L increases, and after the bar 51 passes through the detection position of the density sensor 6, the detected value decreases. Next, when the bar 52 reaches the detection position of the density sensor 6, the detected value L increases, and after the bar 52 passes through the detection position of the density sensor 6, the detected value decreases. In the detection result of the print density obtained by the density sensor 6, a point where the curve of the detected value L first becomes the peak is defined as an apex 61, and a point where the curve next becomes the peak is defined as an apex 62.

After the density sensor 6 detects the print density, the CPU 2 determines whether the print medium 43 is the print medium for two-color printing (Act 204).

Specifically, first, the CPU 2 regards the apex 61 of the change of the detected value L shown in FIG. 11 as the print density of the bar 51, and regards the apex 62 as the print density of the bar 52, and compares them with the thresholds α and β. Next, the CPU 2 determines whether each of the bars 51 and 52 is red or black. At this time, when the apex 61 or 62 is not less than β and less than α (β≦L<α), it is determined that the bar is red, and when the apex is not less than the threshold α (α≦L), it is determined that the bar is black. Then, based on the colors of the bars 51 and 52 specified in this way, the CPU 2 determines whether the print medium 43 is the print medium for two-color printing. That is, when the bar 51 is black and the bar 52 is red, the CPU 2 determines that the print medium 43 is the print medium for two-color printing. On the other hand, when both the bars 51 and 52 are black or red, the CPU 2 determines that the print medium 43 is the print medium for one-color printing. When the surface of the print medium 43 on which the thermosensitive layers 45a and 45b are formed does not face the second thermal head 25, the apexes 51 and 52 are not detected, and the color of the bars 51 and 52 can not be determined. In such a case, the CPU 2 determines that the front and the back of the print medium 43 is inversely set.

Next, the CPU 2 stores the determination result of the operation of Act 204 into the determination result holding area 4a formed in the RAM 4 (Act 205). Thereafter, the CPU 2 waits for reception of a print command from the upper equipment 30 (Act 206).

When receiving the print command from the upper equipment 30 through the communication interface 5 (Yes at Act 206), the CPU 2 receives two-color print data to be printed on the print medium 43 (Act 207), and stores the received print data into the second data buffer 15a (Act 208). The CPU 2 refers to the determination result stored in the determination result holding area 4a by the operation of Act 205, and determines whether the print medium 43 is the print medium for two-color printing (Act 209).

When the determination result that the print medium 43 is the print medium for two-color printing is stored in the determination result holding area 4a (Yes at Act 209), the CPU 2 instructs the drive controller 13 and the second head controller 15 to print. At this time, the drive controller 13 drives the conveyance motor 23 to convey the print medium 43, and in synchronization with that, the second head controller 15 controls the applied energy to the second thermal head 25 based on the print data stored in the second data buffer 15a. As described before, when a portion where the print data is black is printed, the first applied energy is applied to the second thermal head 25, and when a portion where the print data is red is printed, the second applied energy is applied. The print medium 43 on which the print data for two-color printing is printed is outputted from the discharge port (not shown) of the thermal printer 1. After the discharge of the print medium 43 is completed, the CPU 2 again waits for a print instruction from the upper equipment 30 (Act 206).

On the other hand, when the determination result that the print medium 43 is the print medium for one-color printing, or the front and the back is inversely set (No at Act 209) is stored in the determination result holding section 4a, the CPU 2 outputs alarm information to the display controller 11. When receiving this, the display controller 11 displays the alarm information on the display device 21, and notifies the user of the error. As the alarm information displayed on the display device 21, for example, when the determination result that the print medium 43 is the print medium for one-color printing is stored in the determination result holding area 4a, a message indicating that the kind of the sheet is not appropriate is adopted. When the determination result that the front and the back of the print medium 43 is inversely set is stored, a message indicating that the front and the back of the sheet is inversely arranged is adopted.

As described above, in the thermal printer 1 of the embodiment, the black and red test patterns are printed on the print medium, and based on the print densities of the test patterns and the thresholds α and β stored in the threshold storage area 3a, it is determined whether the print medium is the print medium for two-color printing. By using the determination result, it becomes possible to perform processing to notify the user that the print medium is not in the state suitable for two-color printing or to stop the printing. Accordingly, the output of a print result not intended by the user can be prevented.

Besides, when the print medium is not for two-color printing, the thermal printer 1 does not perform printing but notifies the error. Thus, the user can easily recognize that the print medium is not appropriately set, and can quickly perform such a process as to replace the print medium. Besides, wasteful printing is omitted, and the print medium can be saved.

In addition, the determination is performed when the system of the thermal printer 1 is started, or the determination result is stored in the determination result holding area 4a, and in this relation, the same effects as the first embodiment are naturally obtained.

Incidentally, in the respective embodiments, the description is made on the assumption that the second thermal head 25 prints the test pattern. However, the first thermal head 24 may print the test pattern. In this case, the density sensor 6 is disposed at a position where the print density of the print result of the first thermal head 24 can be detected. In the first embodiment, a change has only to be made such that when the apex 60 of the detected value L obtained by the density sensor 6 is not less than the threshold α (α≦L), the determination section 2b determines that the print medium is correctly set. Besides, in the second embodiment, a change has only to be made such that the first thermal head 24, not the second thermal head 25, prints data.

Besides, in the respective embodiments, although the description is made on the case where the bars 50 to 52 are printed as the test patterns. However, the shape of the test pattern is not limited to the bar shape, and another pattern such as a circular or square pattern may be adopted.

Besides, also in the second embodiment, the print data interchanging section 2c is operated, and the print data stored in the second data buffer 15a is shifted into the first data buffer 14a, and the printing on the print medium may be performed by the first thermal head 24.

Besides, in the second embodiment, the description is made while the error is notified by the display of the alarm information on the display device 21. However, the method of notifying the error is not limited to the display of the alarm information on the display device 21. In addition to this, alarm information may be outputted to the upper equipment 30 through the communication interface 5, or a speaker is provided in the thermal printer 1, and a voice or alarm sound may be outputted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A thermal printer comprising:
a first thermal head to print data on one surface of a print medium in which both surfaces are colored in different colors;
a second thermal head to print data on the other surface of the print medium different from the print surface of the first thermal head;
a density information storage section to store information relating to a density of a first color printed on the one surface of the print medium by the first thermal head and information relating to a density of a second color printed on the other surface of the print medium by the second thermal head;
a test image print section to print a test image on the print medium set in the thermal printer by controlling the first thermal head or the second thermal head;
a density detection section to detect a print density of the test image printed by the test image print section; and
a determination section to determine whether a front and a back of the print medium set in the thermal printer is normal based on the print density of the test image detected by the density detection section and the information stored in the density information storage section.

2. The printer of claim 1, wherein
the density information storage section stores a first threshold for distinguishing the density of the first color and a second threshold for distinguishing the density of the second color, and
the determination section compares the print density of the test image detected by the density detection section with the first threshold and the second threshold, and determines whether the front and the back of the print medium set in the thermal printer is normal.

3. The thermal printer of claim 1, further comprising:
a first print data storage section to store print data to be printed by the first thermal head;
a second print data storage section to store print data to be printed by the second thermal head; and
a print data interchanging section to interchange the print data stored in the first print data storage section and the print data stored in the second print data storage section when the determination section determines that the front and the back of the print medium set in the thermal printer is not normal.

4. The printer of claim 1, wherein when the print medium is first loaded after the print medium is set in the thermal printer, the test image print section prints the test image.

5. The printer of claim 1, further comprising a determination result holding section to store a determination result of the determination section.

6. A thermal printer comprising:
a thermal head to generate heat up to a temperature corresponding to an applied energy and to print data on a print medium;
a density information storage section to store information relating to a density of a first color in which a print medium for two-color printing is colored when the thermal head generates the heat by a first applied energy and information relating to a density of a second color in which the print medium for two-color printing is colored when the thermal head generates the heat by a second applied energy;
a test image print section to print test images on the print medium set in the thermal printer by controlling the thermal head;
a density detection section to detect print densities of the test images printed by the test image print section; and
a determination section to determine whether the print medium set in the thermal printer is the print medium for two-color printing based on the print densities of the test images detected by the density detection section and the information stored in the density information storage section.

7. The printer of claim 6, wherein
the density information storage section stores a first threshold for distinguishing the density of the first color and a second threshold for distinguishing the density of the second color,
the test image print section controls the thermal head to print the test images on the print medium by the first applied energy and the second applied energy,
the density detection section detects the print densities of the test images printed by the first applied energy and the second applied energy, and
the determination section compares the print densities, which are detected by the density detection section, of the test images printed by the first applied energy and the second applied energy with the first threshold and the second threshold stored in the density information storage section, and determines whether the print medium set in the thermal printer is the print medium for two-color printing.

8. The printer of claim 6, further comprising an error notification section to notify an error when the determination section determines that the print medium set in the thermal printer is not for two-color printing.

9. The printer of claim 6, wherein when the print medium is first loaded after the print medium is set in the thermal printer, the test image print section prints the test images.

10. The printer of claim 6, further comprising a determination result holding section to store a determination result of the determination section.
